(19) United States
(12) Patent Application Publication
(10) Pub. No.: US 2012/0132814 A1
(43) Pub. Date: May 31, 2012

(54) RADIATION DETECTION DEVICE, SYSTEM AND RELATED METHODS

(76) Inventor: Irving WEINBERG, Bethesda, MD (US)

(21) Appl. No.: 12/037,423

(22) Filed: Feb. 26, 2008

Related U.S. Application Data
(60) Provisional application No. 60/903,310, filed on Feb. 26, 2007.

(51) Int. Cl. G01T 1/20

(52) U.S. Cl. 250/362; 250/366

(57) ABSTRACT

An omni-directional sensor device is provided for detecting radiation emission sources, such as nuclear and atomic weapons and dirty bombs. The omni-directional sensor device is constructed as a three-dimensional structure formed of a plurality of walls of gamma ray detector arrays. The walls face in multiple directions to establish omni-directional sensing of incident gamma rays from substantially all directions. As constructed, a first wall of the device intercepts an incident gamma ray at a first location. The gamma ray experiences a Compton scattering effect whereby a deflected gamma ray is emitted into the inner chamber of the device before intercepting a second wall of the device at a second location. The first and second locations can be used to trace the location of the emission source. Also provided are radiation detection systems including the omni-directional sensor devices, and methods of locating a radiation emission source.

### CROSS-REFERENCE TO RELATED APPLICATIONS

This application claims the benefit of priority under 35 U.S.C. §119(e) of U.S. Provisional Application No. 60/903,310 filed Feb. 26, 2007 entitled “Innovative configurations of radiation detection and characterization methods,” the complete disclosure of which is incorporated herein by reference.

### FIELD OF THE INVENTION

The present invention in its exemplary embodiments relates to devices, systems and methods for detecting and locating radioactive materials and weapons, and finds particular applicability to the field of homeland security.

### BACKGROUND OF THE INVENTION

Global terrorism presents a dire threat to the United States in particular. Of all of the terrorist threats presented by global terrorism, the most vexatious and insidious are homeland radiation threats. In a worse case scenario, the radiation threat would involve a nuclear or atomic weapon nefariously smuggled into the United States. A successful detonation of a nuclear bomb could potentially destroy entire cities and create a radioactive cloud which disperses radiation over hundreds of square miles. The humanitarian strife, economic devastation, and widespread fear that a successful nuclear or atomic bomb attack would create are incomprehensible.

Less destructive but nonetheless still catastrophic improvised weapons such as “dirty bombs” or radiological dispersal devices likewise present a potentially serious terrorist threat. Dirty bombs contain conventional explosive and radioactive material. Detonation of the conventional explosive could disperse the radioactive material in a populated area, such as a city. While it is widely believed that the number of fatalities that would result from a dirty bomb would be limited, it is generally agreed that the event would cause widespread panic and crime, contaminate properties, and require costly cleanup efforts.

Protecting the United States from radioactive threats demands technical solutions which are highly reliable and are capable of widespread implementation in a relatively short amount of time to protect the numerous potential targets in the United States and the rest of the world. Recent instances of special nuclear material (SNM) smuggling in Europe suggest that we do not have the luxury of time to delay before deploying effective systems. One technical solution is to provide a detection device capable of locating nuclear and other radioactive materials and weapons. Early detection would allow police and other authorized personnel to locate and disable the weapons before they could be assembled and/or detonated. Because there is little margin for error, detection devices should operate with high sensitivity to radiation and with very low error rates.

U.S. Pat. No. 7,183,554, the complete disclosure of which is incorporated herein by reference, discloses a gamma ray imaging detector with three-dimensional event positioning. The detector design relies on the use of a coded-aperture mask in the front of each face of the detector for determining the direction from which a detected photon originated.

### SUMMARY OF THE INVENTION

A first aspect of the invention provides an omni-directional sensor device including a plurality of walls of gamma ray detector arrays facing in multiple directions to collectively establish a three-dimensional structure having an inner chamber. The walls are arranged for intercepting an incident gamma ray from substantially any direction. A first wall intercepts an incident gamma ray at a first location and produces a Compton scattered gamma ray which passes through at least a portion of the inner chamber. A second wall intercepts the Compton scattered gamma ray at a second location. The gamma ray detectors include a scintillator responsive to gamma rays for producing a plurality of scintillation photons, a first sensor positioned adjacent a first surface of the scintillator for receiving a first portion of the plurality of scintillation photons and for generating a first electrical output signal proportional to the received first portion of the plurality of scintillation photons, and a second sensor positioned adjacent a second surface of the scintillator for receiving a second portion of the plurality of scintillation photons and for generating a second electrical output signal proportional to the received second portion of the plurality of scintillation photons.

According to a second aspect of the invention, an omni-directional sensor device is provided. The omni-directional sensor device includes a plurality of outer walls of gamma ray detector arrays collectively forming a three-dimensional structure with an inner chamber and at least one interior wall of gamma ray detectors in the inner chamber. The outer walls face in multiple directions to establish omni-directional sensing of incident gamma rays from substantially all directions for producing Compton scattered gamma rays in response to the gamma rays incident on the outer walls. The interior wall is positioned for intercepting at least some of the Compton scattered gamma rays passing through at least a portion of the inner chamber.

A third aspect of the invention provides a radiation detection system featuring an omni-directional sensor device and a processor. The omni-directional sensor device features a plurality of walls of gamma ray detector arrays facing in multiple directions to collectively establish a three-dimensional structure having an inner chamber. The walls are arranged for intercepting an incident gamma ray from substantially any direction. The plurality of walls include a first wall for intercepting an incident gamma ray at a first location and for producing a Compton scattered gamma ray which passes through at least a portion of the inner chamber, and a second wall for intercepting the Compton scattered gamma ray at a second location. The gamma ray detectors each include a scintillator responsive to gamma rays for producing a plurality of scintillation photons, a first sensor positioned adjacent a first surface of the scintillator for receiving a first portion of the plurality of scintillation photons and for generating a first electrical output signal proportional to the received first portion of the plurality of scintillation photons, and a second sensor positioned adjacent a second surface of the scintillator for receiving a second portion of the plurality of scintillation photons and for generating a second electrical output signal proportional to the received second portion of the plurality of scintillation photons. The processor determines the origination direction of the incident gamma ray based on at least the coordinates of the incident gamma ray at the first location and the coordinates of the Compton scattered gamma ray at the second location.

According to a fourth aspect of the invention, a radiation detection system including an omni-directional sensor device and a processor is provided. The omni-directional sensor device includes a plurality of outer walls of gamma ray detector arrays arranged relative to one another to collectively form a three-dimensional structure having an inner chamber. The outer walls face in multiple directions to establish omni-directional sensing of incident gamma rays from substantially all directions so that gamma rays incident on the outer walls at first locations produce Compton scattered gamma rays which pass through at least a portion of the inner chamber. The omni-directional sensor device further includes at least one interior wall comprising a gamma ray detector array. The interior wall is positioned within the inner chamber for intercepting at least some of the Compton scattered gamma rays at second locations. The processor determines the origination direction of the incident gamma rays based on at least the coordinates of the incident gamma rays at the first locations and the coordinates of the Compton scattered gamma rays at the second locations.

A fifth aspect of the invention provides a method of locating a radiation emission source. According to the method, an incident gamma ray emitted from a radiation emission source is intercepted at a first reference point of an omni-directional sensor device. The omni-directional sensor device includes a plurality of walls of gamma ray detector arrays arranged relative to one another to collectively establish a substantially omni-directional sensing, three-dimensional structure having an inner chamber for sensing of incident gamma rays from substantially all directions. The gamma ray is intercepted at a first wall, and may experience Compton scattering at the first wall and produce a deflected gamma ray which passes through at least a portion of the inner chamber. The deflected gamma ray is intercepted at a second reference point of a second wall of the device. The origination direction of the incident gamma ray is determined based on at least the first and second reference points.

Additional aspects of the invention, including other devices, imaging devices, systems, and methods to those set forth above, will become apparent upon viewing the accompanying drawings and reading the detailed description below.

### BRIEF DESCRIPTION OF THE DRAWINGS

The accompanying drawings are incorporated in and constitute a part of the specification. The drawings, together with the general description given above and the detailed description of the exemplary embodiment(s) and method(s) given below, serve to explain the principles of the invention. In such drawings:

FIG. 1 is a simplified schematic of a radiation detection system carried in a vehicle according to an embodiment of the invention;

FIG. 2 is a front partially phantom view of a partially disassembled omni-directional sensor device (scanner) according to an embodiment of the invention;

FIG. 3 is a fragmentary side view of a gamma ray imaging detector array of one of the walls of the omni-directional sensor device of FIG. 2;

FIG. 4 is a fragmentary end view of the gamma ray imaging detector array of FIG. 3;

FIG. 5 is a fragmentary, sectional view of a gamma ray imaging detector of a detector array according to an embodiment of the invention;

FIG. 6 is an overhead view of a roving vehicle scanning for radioactive material from multiple positions; and

FIG. 7 is a view showing the operation of a Compton camera, in particular a deflected gamma ray and a computer-generated cone of response for reconstructing an image of a radiation source.

### DETAILED DESCRIPTION OF EXEMPLARY EMBODIMENT(S) AND EXEMPLARY METHOD(S) OF THE INVENTION

Reference will now be made in detail to exemplary embodiment(s) and method(s) of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the exemplary embodiments and methods.

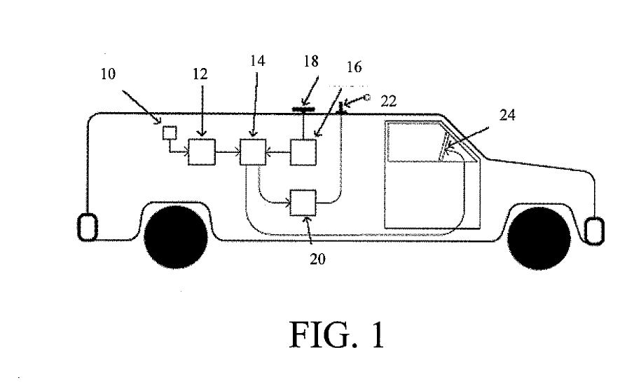

Referring now more particularly to the drawings, there is shown in FIG. 1 a radiation detection system according to an embodiment of the invention. The system is carried on a roving vehicle such as a truck or van, as shown. Alternative vehicles and other transportation means may be employed, such as automobiles, buses, SUVs, airplanes, helicopters, boats, and others. Although not shown in FIG. 1, the battery, generator, or motor of the vehicle may serve the dual purpose of powering the radiation detection system. The truck's battery and/or generator can provide, for example, up to 3000 watts of power needed to operate the radiation detection system.

The radiation detection system as illustrated in FIG. 1 includes an omni-directional sensor device 10, detector electronics 12, a computer 14, a navigation system 16, a GPS antenna 18, a communication system 20, a communication antenna 22, and a detector system real-time display 24 in communication with one another. Electrical, wireless, and other connections may be established between the components of the radiation detection system. It should be understood that the radiation detection system may include fewer or more components than illustrated, and/or different electrical configurations.

Imaging Device

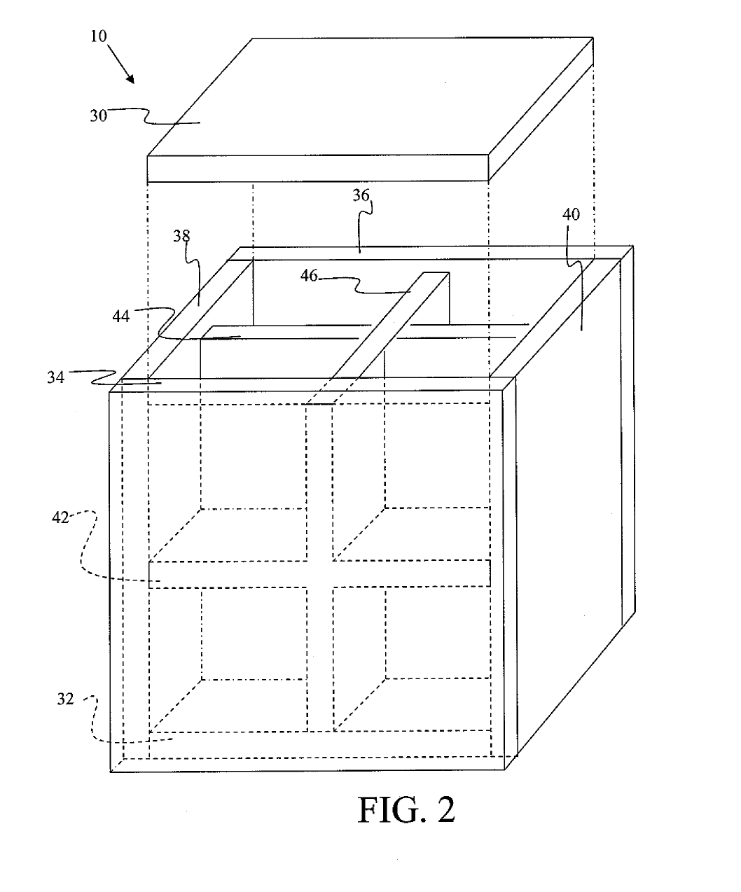

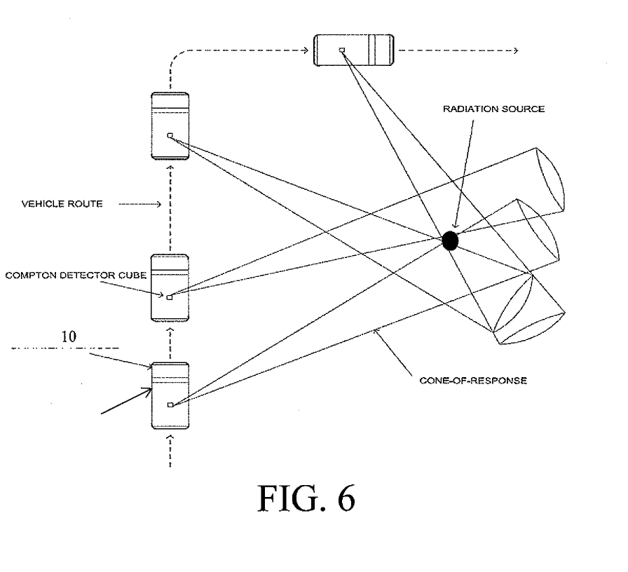

In an exemplary embodiment the omni-directional sensor device is embodied as an imaging device 10. It should be understood that sensor device need not necessarily provide imaging capabilities. As best shown in FIG. 2, the illustrated imaging device 10 is an omni-directional device/scanner shaped as a cube with near isotropic (omni-directional) sensitivity for sensing incident gamma rays from substantially all directions without requiring rotation of the device 10 or movement of the radiation source. Consequently, the device 10 need not be pointed in the specific direction of the radiation source to register a reading. Radiation is sampled simultaneously from all sides of the device 10. Any of the outer walls may serve as the “first wall” at which the incident gamma ray is intercepted. Which outer wall intercepts the incident gamma ray will in all likelihood depend upon the arrangement of device 10 relative to the radiation source. In all likelihood, the outer wall closest to or facing the radiation source will intercept the incident gamma ray and be designated the first wall for that particular incident gamma ray. As the device 10 is moved, e.g., in a vehicle as shown in FIG. 6, the same or a different outer wall of device 10 may intercept subsequent gamma ray emissions.

The cubic structure of sensor device 10 is formed of six outer (or exterior) walls and three interior walls. The six outer walls include top and bottom walls 30, 32 parallel to one another, front and rear walls 34, 36 parallel to one another and perpendicular to the top and bottom walls 30, 32, and left and right side walls 38, 40 parallel to one another and perpendicular to the top, bottom, front, and rear walls 30, 32, 34, 36. The outer walls collectively define an inner chamber in which the three interior walls (also referred to herein as vanes) 42, 44, 46 are situated. A first interior wall 42 is shown horizontally oriented, and is parallel to and centrally disposed midway between the top and bottom walls 30, 32. The four edges of first interior wall 42 are in continuous contact with side walls 38 and 40 and front and rear walls 34 and 36, respectively. A second interior wall 44 is parallel to and centrally disposed midway between the front and rear walls 34, 36. The four edges of second interior wall 44 are in continuous contact with top and bottom walls 30 and 32 and side walls 38 and 40, respectively. A third interior wall 46 is parallel to and centrally disposed midway between the left and right side walls 38, 40. The four edges of third interior wall 46 are in continuous contact with top and bottom walls 30 and 32 and front and rear walls 34 and 36, respectively. The three interior walls or vanes 42, 44, and 46 are perpendicular to one another to partition the inner chamber into eight compartments of substantially equal volume, and to segment each outer wall 30, 32, 34, 36, 38, 40 into four quadrants of substantially equal area.

According to one specific embodiment, the nine walls of a cubic imaging device 10 each have opposite square-shaped surfaces of approximately 50 cm width and length, and a thickness of approximately 4 cm. As discussed below, these dimensions are provided merely by way of example. It is approximated that imaging device 10 of this size, using a 1 mCi source 100 meters from the device, will observe approximately 25 counts per second. Of course, device 10 is scalable to larger and smaller dimensions, as desired. Scaling device 10 will affect the count frequency. Size increases, however, will be accompanied by significant cost increases, power consumption, and weight penalties.

It should be understood that omni-directional sensor device 10 may possess three-dimensional shapes other than that of a cube. Device 10 may be shaped, for example, as a different parallelepiped or other three-dimensional geometrical shapes. Device 10 may be in the shape of a sphere or pyramid, for example. These are just some of the possible shapes of device 10. While device 10 is illustrated as including three internal walls 42, 44, 46, it should be understood that the internal walls may be omitted. Alternatively, device 10 may possess only one or two internal walls, or more than three internal walls. Further, the internal walls may be positioned in alternative arrangements than shown in FIG. 2.

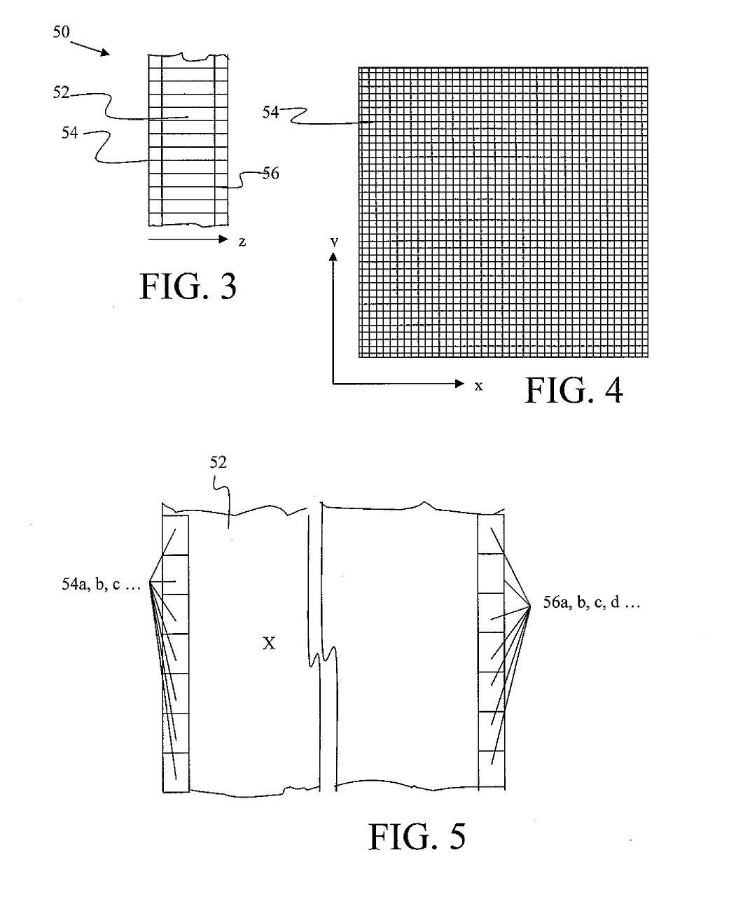

As best shown in FIGS. 3 and 4, each wall 30, 32, 34, 36, 38, 40, 42, 44, 46 of imaging device 10 is composed of an array of gamma ray detectors 50. Gamma ray detectors 50 collectively establish an array or matrix of detectors extending in the x and y directions, as shown in the end view the array of gamma ray detectors 50 of FIG. 4. Individual gamma ray detectors 50 are represented in FIG. 4 as individual squares arranged next to one another to define rows and on top of one another to define columns. For square area walls, as for instance found in cubic detector 10, walls will have an approximately equal number of rows and columns. It should be understood that the array of a wall may contain tens, hundreds, or thousands of gamma ray detectors 50. Depending upon the desired shape of imaging device 10, e.g., non-cubic, the number of rows and columns in an array are not necessarily equal to one another. Further, an array of gamma ray detectors 50 may have its detectors arranged in different patterns than shown, or randomly. Other modifications to the array are within the scope of the invention.

As best shown in FIGS. 3 and 5, each gamma ray detector 30 includes a scintillator 52, a first sensor 54, and a second sensor 56. Each scintillator 52 is responsive to an incoming or incident gamma rays for partially absorbing the gamma ray and responsively producing a plurality of scintillation photons. Scintillator 52 is preferably a scintillating crystal such as, for example, cesium iodide (CsI) appropriately doped, e.g., with thallium. CsI is reliable, inexpensive, requires no or little cooling to operate, and under optimal conditions yields very good energy resolution (e.g., about 4.4% at 662 keV and about 7.5% at 122 keV for thallium-doped CsI). Methods of obtaining large volumes of high quality CsI are well known. See Study of the Radiation Hardness of CsI(Tl) Crystals for the BELLE Detector. K. Kazui et al., Nucl. Instr. Meth. A 394 1997:46. CsI is also commercially available. Sodium iodide (NaI) is another example of a scintillating material which can be used. However, NaI generates fewer photons per MeV than CsI—Tl when detectors sensitive in the green spectral range (e.g., silicon photodiodes) are used. Other transparent scintillating crystals may be selected. Alternatively, scintillators 52 may comprise relatively transparent sintered materials, liquids, and/or plastic materials. Plastic is less expensive than scintillating crystals, but results in higher volume and poorer energy resolution than certain crystals such as CsI.

In an exemplary embodiment scintillators 52 are shaped as square rods with sensors 54, 56 coupled at its opposite ends, although it should be understood that scintillators 52 may have rectangular, round, hexagonal, or any other suitable shape cross sections. The thickness of scintillators 52 may be selected based on the desired stopping power of the gamma ray detectors 50. Generally, scintillators 52 suited for the present invention may have a thickness on the order of about 4 cm. Scintillators 52 may have overall dimensions of, for example, 4 cm by 1 cm by 1 cm. The height and width of sensors 54, 56 may be equal to the height and width of scintillator 52, e.g., 1 cm by 1 cm sensors 54, 56 for a 4 cm×1 cm×1 cm scintillator 52. Sensors 54, 56 may be continuous structures or may be formed of multiple smaller area detectors connected together. Other detector dimensions and configurations may be selected.

The construction of imaging device 10 desirably intercepts an incident gamma ray emanating from substantially any direction. The wall in which a particular gamma ray is intercepted is usually an outer wall, and is designated as the first wall for that particular gamma ray. In a Compton scattering interaction, the incident gamma ray deposits some but not all of its energy in the first wall, and continues its flight along a deflected path. The deflected gamma ray deposits at least a portion its remaining energy via Compton scattering, if not all of its remaining energy via photoelectric absorption, in another of the device's walls. The wall in which the particular Compton scattered gamma ray is intercepted is designated as the second wall for that particular gamma ray. The second wall may be either an inner wall or another outer wall of imaging device 10, depending upon the flight path of the deflected gamma ray.

First sensor 54 positioned adjacent one end surface of scintillator 52 at the point of interception receives a first portion of the plurality of scintillation photons generated by the interaction of the gamma ray in scintillator 52, and creates a first electrical output signal proportional to the first portion of scintillation photons received from scintillator 52. Second sensor 56 positioned adjacent an opposite end surface of scintillator 52 at the point of interception receives a second portion of the plurality of scintillation photons and generates a second electrical output signal proportional to the second portion of scintillation photons received from scintillator 52.

In an exemplary embodiment of the invention sensors 54, 56 are high-gain, low-noise solid-state photodetectors or photodiodes, also commonly known as silicon photomultipliers (SiPM). Silicon photomultipliers can consume microwatts per channel and fire when scintillation photons are received. Small area SiPMs (e.g., about 1 mm×1 mm) can be fabricated with high quantum efficiency (e.g., about 70%). See Critical Comparison of Silicon Photomultipliers and Photomultiplier Tubes for Low Light Sensing Applications, P. J. Hughes, et al., Proc. IEEE TMI 2006. The technology to fabricate larger detectors is within the purview of those skilled in the art. See Novel Type of Avalanche Photodetector Geiger Mode Operation, V. Golovin, et al., Nucl. Inst. And Meth. In Physics Research, A 2004, 518:560-564, the complete disclosure of which is incorporated herein by reference.

Sensors 54, 56 may each comprise an integrated array of micropixels wired together in parallel to a single output or may be composed of several separate devices wired in parallel to form a single common output signal. In an exemplary embodiment, sensor 54 is comprised of a plurality or array of micropixels (also referred to herein as sensor elements), 54a, 54b, 54c, 54d . . . situated on a substrate (e.g., chip or die) and electrically interconnected to quenching elements. Similarly, sensor 56 is comprised of a plurality or array of sensor elements 56a, 56b, 56c, . . . situated on a substrate and electrically connected to quenching elements. Examples of particularly useful sensors are disclosed in U.S. patent application Ser. No. 11/783,613, the complete disclosures of which are incorporated herein by reference. Silicon photomultipliers are relatively thin and essentially transparent to incident gamma rays having energies of interest. Sensors 54, 56 alternatively may be silicon drift photodiodes. Because of their relative transparent nature, sensors 54, 56 may be mounted directly to the end surfaces of their associated scintillator 52 without significantly attenuating the flux of gamma rays reaching the scintillator 52.

As described below, by providing arrays of micropixels at the opposite ends of scintillator 52, it is possible to determine the x, y, and z coordinates of the gamma ray absorption event within scintillator 52, and the energy intensity of the absorbed gamma ray.

Although the figures illustrate gamma ray detectors 50 possessing scintillators, it should be understood that other detectors may be used, particularly with respect to embodiments of the omni-directional sensor device having one or more internal walls. For example, the gamma ray detectors may comprise solid state detectors such as cadmium-zinc-telluride detectors, especially for the outer wall detectors.

Determination of Points of Interaction

Imaging device 10 preferably operates passively by detecting radiation that is emitted from surrounding sources and impacts the device 10, rather than actively directing radiation to stimulate emission. As described above, an incident high-energy gamma ray originating from a radioactive source is intercepted by a first wall of device 10 facing the radiation source. Because the walls of device 10 collectively face in substantially all directions, device 10 provides substantially omni-directional or isotropic sensing without requiring device 10 to be pointed in a particular direction in which the radiation source is located. A scintillator 52 in an outer wall facing the radiation source partially absorbs the gamma ray. The outer wall which scatters an incident gamma ray is designated as the first wall with respect to that particular gamma ray. The gamma ray with its unabsorbed portion of its energy continues through the wall of device 10, but changes its course of travel and continues in a new direction until it too is partially or completely absorbed by a scintillator in another wall of device 10. This phenomenon is known as Compton scattering.

Scintillator 52 of the first wall absorbs energy of the gamma ray and isotropically emits scintillation photons. A first portion of the scintillator photons is received by the associated sensor 54 at one end of scintillator 52, and a second portion of the scintillator photons is received by the associated sensor 56 at the opposite end of scintillator 52. The sensors 52, 54 produce respective signals which are read by detector electronics 12, as discussed in greater detail below. The signals from sensors 52, 54 identify the scintillator 52 which scattered the gamma ray. The x and y coordinates of the activated scintillator 52 in the first wall's array can then be noted.

The deflected gamma ray exiting the first wall with reduced energy intersects another wall of the device 10. This wall, designated as the second wall with respect to the particular deflected gamma ray, absorbs either a portion or all of the remaining energy of the deflected gamma ray. The sensors 52, 54 associated with the scintillator 52 at the point of interaction of the second wall produce a second set of signals which are read by detector electronics 12 to locate the x and y coordinates of the absorption event in the second wall.

The incident and scattered gamma ray is typically absorbed at a point along the depth (z-axis in FIG. 3) of scintillator 52, rather than at the end face of the scintillator 52. This point of interaction (POI) at which the gamma ray is absorbed, and in particular the accurate measurement of the x, y, and z-coordinates of the POI, are all important for successfully backtracking the origination point of the gamma ray. See “Maximum Likelihood Positioning in the Scintillation Camera Using Depth of Interaction,” D. Gagnon et al., IEEE Transactions on Medical Imaging, Vol. 12, No. 1, March 1993, pp. 101-07.

The position of the absorption event along the depth (z axis in FIG. 3) of the scintillator 52, also known as the depth of interaction of the gamma ray, can be estimated from the relative signal intensities measured from the sensors in view of the proportionality which exists between the signal intensity and the depth of interaction. The depth of interaction from a first “A”-end of scintillator 52 is proportional to I_{A}(I_{A}+I_{B}), wherein I=signal intensity. Likewise, the depth of interaction from a second “B”-end of scintillator 52 is proportion to I_{B}/(I_{A}+I_{B}), wherein I=signal intensity. The energy lost by the gamma ray in the Compton scattering interaction or photoelectric absorption interaction is proportional to (I_{A}+I_{B}).

Determination of Origination Source

In operation, gamma rays (with energy Eᵢ) emanating from a radioactive source (see FIG. 6) are intercepted by one of outer walls 30, 32, 34, 36, 38, 40 of imaging device 10 and experience a Compton scatter interaction to provide a first reference point. Because of its isotropic sensing capability, device 10 does not need to be pointed in a particular direction coinciding to the radiation source to operate effectively. Further, if device 10 is rotated relative to the radiation source, e.g., as a vehicle carrying device 10 turns as in FIG. 6, device 10 need not be repositioned to account for the movement or reorientation of the vehicle.

The gamma ray is deflected by the outer wall according to the Klein Nishina equation. An amount of energy (i.e., ΔE) is deposited in the outer wall, in particular is collected by scintillators (e.g., cesium iodide) 52, and read out by sensors (e.g., SiPMs) 54, 56 and associated electronics 12. The scattered gamma ray with its remaining energy (E_{f}) then passes into inner chamber before interacting with a second wall to provide a second reference point. The second wall may be either an interior wall 42, 44, 46 or another one of outer walls, depending upon the path of flight of the redirected gamma ray. In this second interaction, the scattered gamma ray deposits either its remaining energy (E_{f}) via a photoelectric interaction or a portion of its energy via a second Compton scattering interaction. In the event that the second interaction is a Compton scattering interaction occurring at an interior wall 42, 44, 46, i.e., the gamma ray's energy is not depleted, the gamma ray will again be deflected and, after continuing its flight through the inner chamber, will interact with still another wall to establish a third reference point. The third wall at which this third reference point is established may be an outer wall or another interior wall, depending upon the path of flight of the redirected gamma ray. Advantageously, this third reference point, made possible by the incorporation of internal walls (or vanes) into device 10, facilitates the estimation of the total energy of the incident gamma ray.

In an above-described alternative embodiment in which interior walls 42, 44, 46 are omitted from imaging device 10, the incoming gamma ray will provide a first reference point at the first outer wall which the gamma ray interacts with, and a second reference point at the second outer wall with which the scattered gamma ray interacts. A third reference point will likely not be provided in this alternative embodiment.

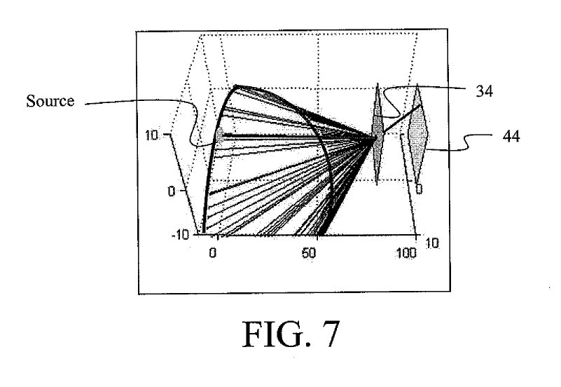

In the illustration of FIG. 7, a source emits a gamma ray that strikes one of the outer walls, such as front wall 34, where the gamma ray deposits some of its energy (ΔE). A Compton scattered gamma ray is deflected and either the remainder of its energy is deposited via photoelectric absorption or a portion of its energy is deposited via another Compton interaction in a second wall. The second wall may be an internal wall, such as inner wall 44, or another outer wall. The locations of gamma-ray interactions in two or more walls, e.g., 34 and 44, generate a vector pointing in the general direction of the radiation source. The energy loss in the first scatter defines a cone around the vector, with angle related to ΔE. Computer 14 calculates the cone of ray paths that could have resulted in an angular deflection corresponding to ΔE.

As shown in FIG. 6, multiple readings are taken at various locations as the system is transported, for example, in a roving truck. In FIG. 6, four cones of response generated by gamma rays at multiple locations are back-projected and reconstructed to derive the likely location of the gamma-ray source. This location of the gamma-ray source coincides where the cones of response intersect one another. For the sake of convenience, the cones of response in FIG. 6 are depicted with the same scatter angle. In reality, different Compton scattering interactions lead to the deposition of different amount of energy, which in turn would correspond to cones of response with different cone angles. In iterative reconstruction theory, the back-projection image is considered a baseline, whose resolution improves with successive iterations. It is estimated that this detector system provides a spatial resolution at 100 m on the order of six meters full-width at half-maximum (“FWHM”).

Advantageously, and as best shown with reference to FIG. 6, exemplary designs of imaging device 10, especially its cubic design, provide nearly-isotropic count sensitivity to the entire field-of-view. Omni-directional sensing of a radioactive source in substantially all directions is created without the need to rotate or reposition imaging device 10 in order to maintain high count sensitivity as the vehicle carrying the device moves and turns.

Noise Reduction

Noisy electrical environments and cosmic-ray muons which could potentially lead to false-positive alarms may be mitigated by including electrical shielding, muon-rejecting strategies, coincidence logic and/or discrimination against background cosmic radiation.

The use of electrical shielding is not shown in the figures. However, imaging device 10 may be surrounded by a conductive shell for noise reduction. For example, the shell may comprise a metal (e.g., aluminum) with a padded (e.g., Styrofoam) backing for stability. The shell is thin enough to transmit gamma rays with energies of greater than 40 keV.

Muons represent noise to the system which, if not addressed, could otherwise lead to false positive results. As charged particles, muons deposit a nearly fixed large amount of energy in each wall they traverse, unlike gamma rays. Consequently, muons may be distinguished from gamma rays by considering two general rules. First, in its exemplary embodiment the imaging device 10 allows for checking of muon deposition in at least two, if not three surfaces, i.e., a first outer wall and then either another outer wall or an inner wall. About 22 MeV of energy is deposited in each wall by a muon, compared to the 3 MeV or lower deposits of gamma rays. Therefore, any deposits more than, for example, about 10 MeV in a single crystal can be disregarded as emanating from muons. Second, muons travel a relatively straight line through the walls of imaging device 10 compared to a deflected gamma ray. For example, the deflection of 4 GeV muons as they traverse a 4 cm thick CsI layer would be about 7 milliradians, with the angle scaling approximately as 1/E(muon) for the relevant range of muon energies, and approximately as sqrt(CsI thickness). A 7 milliradian deflection extrapolated over a 25 cm length would result in a position deflection of 1.75 mm.

Coincidence is a well-known method of improving noise rejection. Coincidence confers excellent stability against noise from spurious electrical impulses generated in the readout electronics (e.g., from thermal noise) or disintegrations from low levels of cesium-137 (i.e., 13 mBq/kg) within the CsI detectors. Critical Comparison of Silicon Photomultipliers and Photomultiplier Tubes for Low Light Sensing Applications, P J Hughes, et al., Proc. IEEE TMI 2006.

Hardware and Software

According to an embodiment of the invention, detector electronics 12 include application specific integrated circuits (ASIC) on readout boards or integrated into the photodetectors for reading out sensors 54, 56. Many currently available devices suitable for detector electronics 12 have a single multiplexed output, and may be digitized together in blocks of 108 input channels with a single serial output analog-to-digital converter (ADC), located next to the ASICs. All of the ADCs, as well as the output multiplexers are operated in parallel by a Master Controller. The ADC outputs are transferred (e.g., via twisted pair ribbon cable) to the Master Controller, where they are accumulated in serial shift registers within a field programmable gate arrays (FPGA), such as a Xilinx FPGA. After each digitization cycle, the data from the shift registers is transferred to a dual port memory (also within the FPGA), where the entire event data are accumulated. The next ASIC channel is then digitized, with this cycle repeating for a total of 108 times at which point all ASIC channels have been digitized, and the entire event is accumulated. Optionally, data sparsification within the readout system reduces event size. If needed, the Master Controller can incorporate a Data Reducer, within the FPGA, which allows for a threshold table to be updated as needed.

Each ADC output from the serial shift registers is compared to the relevant channel's threshold. If the threshold is not exceeded, the output for that channel is discarded. If the channel threshold is exceeded, the data and channel's address are passed on to a dual port memory. The threshold table is updateable automatically using algorithms based on periodical pedestal and calibration runs (with safeguards to prevent unreasonable values from being used) as well as by command input from the operator. Such command input may be based on a simple graphical user interface (GUI) requiring only minimal training in operating the system. A second Xilinx FPGA within the Master Controller is used for trigger logic, which starts each event cycle. Individual trigger signals from each of the detector panels are flagged to determine coincidence. Use of FPGAs allows the trigger logic to be modified as needed, with multiple trigger types and flags possible (e.g., based on the signal energy, rate, coincidences between sub-detectors, anti-coincidences to reduce background, etc.). The Data Computer interface may be based on, for example, a Cypress CY7C68013A USB 2.0 peripheral controller. The high speed USB endpoints and internal processor within this device make it a suitable choice for the transfer of large blocks of data into a computer, as well as providing additional endpoints for transfer of control and status information. The dual port memories within the FPGA can be easily interfaced to the high speed endpoint FIFO buffers for efficient transfer of data events.

Computer 14, such as a laptop computer, communicates with detector electronics 12 and serves as the Data Acquisition (DAQ) system. USB ports interface to the Master Controller, GPS, and communications system 20. The scanner count rate may be monitored in real time, and compared with a non-paralyzable detection method (e.g., Geiger counter), in the rare case that the electronics and/or detectors are swamped because of a high activity source in the close vicinity (e.g., a thyroid cancer patient being treated with radioactive iodine walking by). In the event of a variance between the scanner count rate and the non-paralyzable system, the operator is provided with the option of reducing voltage to selected channels in order to lower count sensitivity.

Computer 14 also receives inputs from high-resolution global positioning/inertial navigation system (GPS/INS) 16 having GPS antenna 18. Inertial backup may be used in case of power loss or loss of satellite signal. Computer 14 integrates positioning data of GPS/INS 16 or its backup with the gamma ray data collected from imaging device 10 in real time in order to provide scanner location and orientation needed for reconstructing images, for updating images of computer-aided detection of nuclear materials, and for implementing effective report, command, and control functions. A quantitative image is generated and presented to the user via a graphic user interface (GUI) 24. The GUI includes tools to extract spectral information from the gamma-ray data and display this information to the user at a desired location, such as in the cab or back of a roving truck or van. Computer-assisted detection and segmentation routines can generate parametric images consistent with the presence of a selected radioisotope. Multi-spectral images can be realized by combining practices of spectral analysis algorithms successfully used to deconvolve low-photon gamma-ray spectra (see Automatic Analysis of Gamma-Ray Spectra from Germanium Detectors. G W Phillips and K W Marlow, Nuc. Instr. Meth. In Physics Research, 1976 137:525-536) with flexible image reconstruction algorithms (see Implementation Reconstruction with Handheld Gamma Cameras, I. Weinberg, et al., IEEE Proceedings of the Medical Imaging Conference, 2000).

With respect to software, a limited angle reconstruction technique ideal for roving vehicles (e.g., trucks or vans) may be implemented to provide angular and spatial resolution. Isotope identification and deconvolution algorithms, some of which are already being used by the Department of Energy to detect illicit plutonium, may be adapted. A net-centric reporting method from medical imaging insures timely and appropriate command and control.

Software may also implement digital image fusion routines in order to increase diagnostic confidence. The images may be derived from video cameras mounted in the vehicle, or from maps downloaded from satellites or in memory. The image fusion routines may employ affine transforms and other tools used in medical imaging.

The software may include flexible image reconstruction algorithms adapted to integrate position-sensing information. The application of iterative reconstruction significantly improves spatial resolution in the direction perpendicular to the detector planes. The reconstruction algorithms are used because the iterative reconstruction process requires a transition matrix to operate. This transition matrix establishes the probability that a source at a particular location will be detected by a detector at another particular location. In typical diagnostic equipment, the source volume is easily defined as the region subtended by fixed detectors. In order to determine the quantitative concentration of radioactivity from arbitrary source locations being viewed by detectors at other arbitrary locations, Monte Carlo simulation methods are employed to assemble a transition matrix for iterative reconstruction. Implementing Reconstruction with Handheld Gamma Cameras, I. Weinberg, et al., IEEE Proceedings of the Medical Imaging Conference, 2000. These Monte Carlo-based methods are also capable of handling additional constraints as might be imposed by terrain or other relevant conditions. The reconstruction methods improve resolution in the direction perpendicular to the ray from the scanner to the source.

Communication system 20 and communication antenna 22 connect the on-board computer 14 with central monitoring facilities. Iridium systems are particularly useful under challenging environmental conditions. A redundant system may be provided in the event that satellites are not viewable, for example, in urban canyons. Alternative communication technologies suitable for use herein include cellular phone networks and Wi-Fi networks. Additionally, advanced compression and encryption programs known in the art of medical imaging data may be used in order to speed reporting when necessary. Remote image report forms funded by the National Institutes of Health for rapid and secure transmission of images in clinical trials have been developed. The model incorporated a net-centric version of the classic nuclear medicine region-of-interest (ROT) concept to reduce transmission time and increase processing speed. In an ROI-based measurement, a user selects an area of interest, and data concerning the user's selected area is stored and transmitted. This scheme significantly reduces the overhead that would normally be involved in transmitting millions of pixels, each of which contains thousands of data bits about energy spectra. The ROI concept is helpful in computer-aided detection (e.g., with neural networks) because the computer can assist the user by automatically selecting an ROI for further analysis. An extension of this ROI communication protocol may be used to facilitate image-based communications between field operators and central data collection and analysis facilities.

The software configuration may also include radionuclide characterization algorithms. These algorithms assess the consistency of the presence of peaks from known radionuclide spectra (Automatic Analysis of Gamma-Ray Spectra from Germanium Detectors, G W Phillips et al, Nuc. Instr. Meth. In Physics Research 1976, 137:525-536), and employ deconvolution algorithms in order to correct for the presence of shielding and instrumentation errors. The use of iterative reconstruction algorithms may be implemented during the image reconstruction process, adding quantitative strength to the results from acquisitions at multiple positions.

Calibration

Self-calibration routines learned from medical imaging may be used to optimize spatial and energy resolution, and image fusion. The system may be calibrated using intrinsic Cs-137 contamination in the CsI(Tl), or with exempt external sources. Alternatively, light emitting diodes in the crystal arrangement may be used for calibration, as done in many high-energy physics experiments.

### Advantages of Exemplary Embodiments

The exemplary embodiment of the present invention provides innovative configurations of radiation detection and characterization methods based on principles that have already been validated in the medical imaging and high energy physics communities. The compact design and light weight of the design facilitate transportation of the system and permit installation of the system in a vehicle capable of navigating city streets in search of radioactive material. Further, accepted and inexpensive components such as cesium iodide scintillators and Geiger-mode silicon photomultipliers may be selected for use in the system to lower costs while still satisfying power, size, and angular resolution requirements. The silicon photomultipliers provide high quantum efficiency, for example, on the order of about 76%. The detector components of embodiments of the invention may be deployed without the need for cooling equipment which, if present, would increase the power and spatial requirements of the system and possibly present potential hazards to the system's operators. The compact design of the system also will permit its production in sufficient capacity for worldwide distribution and use without significantly impacting already-stressed supplies of sodium iodide.

The foregoing detailed description of the certain exemplary embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Modifications and equivalents will be apparent to practitioners skilled in this art and are encompassed within the spirit and scope of the appended claims and their appropriate equivalents.

What is claimed is:

1. An omni-directional sensor device comprising a plurality of walls of gamma ray detector arrays facing in multiple directions to collectively establish a three-dimensional structure having an inner chamber, the plurality of walls arranged for intercepting an incident gamma ray from substantially any direction, the plurality of walls including a first wall for intercepting an incident gamma ray at a first location and for producing a Compton scattered gamma ray which passes through at least a portion of the inner chamber, and a second wall for intercepting the Compton scattered gamma ray at a second location, the gamma ray detector arrays each comprising gamma ray detectors comprising
a scintillator responsive to gamma rays for producing a plurality of scintillation photons, the scintillator having first and second surfaces opposite to one another;
a first sensor positioned adjacent the first surface of the scintillator for receiving a first portion of the plurality of scintillation photons and for generating a first electrical output signal proportional to the received first portion of the plurality of scintillation photons; and
a second sensor positioned adjacent the second surface of the scintillator for receiving a second portion of the plurality of scintillation photons and for generating a second electrical output signal proportional to the received second portion of the plurality of scintillation photons.

2. The omni-directional sensor device of claim 1, wherein the plurality of walls comprise a top wall, a bottom wall, a front wall, a rear wall, and first and second opposing side walls establishing a parallelepiped.

3. The omni-directional sensor device of claim 2, wherein the parallelepiped is cubic.

4. The omni-directional sensor device of claim 2, wherein the plurality of walls further comprises at least one interior wall situated in the inner chamber.

5. The omni-directional sensor device of claim 2, wherein the plurality of walls further comprises first, second, and third interior walls situated in the inner chamber and arranged orthogonally relative to one another.

6. The omni-directional sensor device of claim 1, wherein the scintillator comprises thallium-doped cesium iodide.

7. The omni-directional sensor device of claim 1, wherein the first and second sensors comprise first and second arrays of silicon photomultipliers, respectively.

8. An omni-directional sensor device comprising:
a plurality of outer walls of gamma ray detector arrays arranged relative to one another to collectively form a three-dimensional structure having an inner chamber, the plurality of outer walls facing in multiple directions to establish omni-directional sensing of incident gamma rays from substantially all directions so that gamma rays incident on the outer walls produce Compton scattered gamma rays which pass through at least a portion of the inner chamber; and
at least one interior wall positioned within the inner chamber for intercepting at least some of the Compton scattered gamma rays, the interior wall comprising a gamma ray detector array.

9. The omni-directional sensor device of claim 8, wherein the plurality of walls comprise a top wall, a bottom wall, a front wall, a rear wall, and first and second opposing side walls establishing a parallelepiped.

10. The omni-directional sensor device of claim 9, wherein the parallelepiped is cubic.

11. The omni-directional sensor device of claim 10, wherein said at least one interior wall comprises a first wall, and wherein the omni-directional sensor device further comprises second and third interior walls arranged perpendicularly to one another and to said first wall.

12. The omni-directional sensor device of claim 8, wherein said at least one interior wall comprises a first wall, and wherein the omni-directional sensor device further comprises second and third interior walls arranged perpendicularly to one another and to said first wall.

13. A radiation detection system, comprising:
an omni-directional sensor device comprising a plurality of walls of gamma ray detector arrays facing in multiple directions to collectively establish a three-dimensional structure having an inner chamber, the plurality of walls arranged for intercepting an incident gamma ray from substantially any direction, the plurality of walls including a first wall for intercepting an incident gamma ray at a first location and for producing a Compton scattered gamma ray which passes through at least a portion of the inner chamber, and a second wall for intercepting the Compton scattered gamma ray at a second location, the gamma ray detector arrays each comprising gamma ray detectors comprising
a scintillator responsive to gamma rays for producing a plurality of scintillation photons, the scintillator having first and second surfaces opposite to one another;
a first sensor positioned adjacent the first surface of the scintillator for receiving a first portion of the plurality of scintillation photons and for generating a first electrical output signal proportional to the received first portion of the plurality of scintillation photons; and
a second sensor positioned adjacent the second surface of the scintillator for receiving a second portion of the plurality of scintillation photons and for generating a second electrical output signal proportional to the received second portion of the plurality of scintillation photons; and
a processor for determining the origination direction of the incident gamma ray based on at least the coordinates of the incident gamma ray at the first location and the coordinates of the Compton scattered gamma ray at the second location.

14. The radiation detection system of claim 13, wherein the processor is responsive to the first and second electrical output signals generated by the first and second sensors of the first wall for determining a first depth of the first location within the first wall, and further is responsive to the first and second electrical output signals generated by the first and second sensors of the second wall for determining a second depth of the second location within the second wall.

15. A radiation detection system comprising:
an omni-directional sensor device comprising
a plurality of outer walls of gamma ray detector arrays arranged relative to one another to collectively form a three-dimensional structure having an inner chamber, the plurality of outer walls facing in multiple directions to establish omni-directional sensing of incident gamma rays from substantially all directions so that gamma rays incident on the outer walls at first locations produce Compton scattered gamma rays which pass through at least a portion of the inner chamber; and
at least one interior wall positioned within the inner chamber for intercepting at least some of the Compton scattered gamma rays at second locations, the interior wall comprising a gamma ray detector array; and
a processor for determining the origination direction of the incident gamma ray based on at least the coordinates of the incident gamma ray at the first locations and the coordinates of the Compton scattered gamma ray at the second locations.

16. The radiation detection system of claim 15, wherein the processor is responsive to the first and second electrical output signals generated by the first and second sensors of the first wall for determining a first depth of the first location within the first wall, and further is responsive to the first and second electrical output signals generated by the first and second sensors of the second wall for determining a second depth of the second location within the second wall.

17. The radiation detection system of claim 15, wherein said at least one interior wall comprises a first wall, and wherein the omni-directional sensor device further comprises second and third interior walls arranged perpendicularly to one another and to said first wall.

18. A method of locating a radiation emission source, comprising:
intercepting an incident gamma ray emitted from a radiation emission source at a first reference point of an omni-directional sensor device, the omni-directional sensor device comprising a plurality of walls of gamma ray detector arrays facing in multiple directions to collectively establish a three-dimensional structure having an inner chamber;
allowing the intercepted gamma ray to experience Compton scattering at a first wall of the plurality of walls and produce a deflected gamma ray which passes through at least a portion of the inner chamber;
intercepting the deflected gamma ray at a second reference point of a second wall of the plurality of walls; and
determining the origination direction of the incident gamma ray based on at least the first and second reference points.

19. The method of claim 18, wherein said intercepting is performed in a moving vehicle.

20. The method of claim 18, wherein the omni-directional sensor device is cubic.
